(19) United States
(12) Patent Application Publication
(10) Pub. No.: US 2007/0043813 A1
(43) Pub. Date: Feb. 22, 2007

(54) Method and system for delivering electronic messages using a trusted delivery system

(76) Inventor: Robert Pickup, Beaumaris (AU)

Correspondence Address: OLIFF & BERRIDGE, PLC, P.O. BOX 19928, ALEXANDRIA, VA, 22320, US

(21) Appl. No.: 10/573,408

(22) PCT Filed: Sep. 24, 2004
(86) PCT No.: PCT/AU04/01321

§ 371 Date: Oct. 2, 2006

(30) Foreign Application Priority Data
Sep. 26, 2003 (AU) 2003905265

(51) Int. Cl. G06F 15/16

(52) U.S. Cl. 709/206

(57) ABSTRACT

A method and system for delivering electronic messages from a sender to a recipient over a communications network. The method includes receiving an email message verification request from a recipient mail server. Authorization of an email message is then verified, and the verification step includes generating a hostname using information in the email message transmission and querying a domain name server using the generated hostname. A verification result is transmitted to the recipient mail server. The verification result is valid when the generated hostname is successfully retrieved from the domain name server. The delivery system may be used to minimize, reduce, or eliminate the blocking or deletion of legitimate emails by spam filter applications.

### FIELD OF THE INVENTION

The present invention relates generally to transmitting electronic messages, and more specifically, to a method and system for transmitting electronic messages on a communications network using a trusted delivery system.

### BACKGROUND OF THE INVENTION

Computer users are continually plagued by the delivery of unsolicited electronic message or electronic mail (email). Unsolicited email, often referred to as bulk electronic mail, “spam,” or “Junk email,” is often of a commercial nature sent indiscriminately to individuals, mailing lists, or newsgroups. The prevalence of “spamming” (the sending of spam) over the Internet has Increased dramatically in recent years. The problem has reached epidemic proportions with some users receiving hundreds of unsolicited emails in a short period of time.

In order to combat spamming, various spam management systems have been developed. One system operates on a blacklist approach where the blacklist includes email addresses or characteristics of unwanted emails. When an email is received from an address on the blacklist, the email will be blocked and not automatically shown to the user. Another known system includes the use of a real-time blackhole list The real-time blackhole list includes a list of known spam offenders and their mail relays. Email messages coming from these mail relays will be blocked and not automatically shown to the user.

The widespread use of spam management systems has resulted in other problems whereby legitimate email is falsely identified as spam and deleted without any accountability to the sender or the intended recipient of the email. Legitimate senders of email have no way of knowing if their email has been delivered or if it has been blocked or deleted. This situation created In part by email filters and spam management systems Is a significant problem for everyone who performs transactions using the Internet

The present invention provides a method and system for delivering electronic messages that overcomes or alleviates one or more problems related to email filters and spam management systems.

### SUMMARY OF THE INVENTION

According to one embodiment of the present invention, a method for delivering electronic messages from a sender to a recipient over a communications network is disclosed. The method includes: receiving an email message verification request from a recipient mail server verifying authorization of an email message, wherein verifying authorization of the email message includes generating a hostname using information in the email message transmission and querying a domain name server using the generated hostname; and transmitting a verification result to the recipient mail server, wherein the verification result is valid when the generated hostname is successfully retrieved from the domain name server.

According to one embodiment of the present invention, a method for delivering electronic messages from a sender to a recipient over a communications network is disclosed. The method includes: receiving a delivery request from a sender mail server, the delivery request including a recipient email address and a sender Identification; generating a unique identifier for the message from the sender to the recipient; storing a hostname on a domain name server based upon this unique identifier for email transmission authorization; receiving an email message verification request from a recipient mail server, verifying authorization of an email message, wherein verifying authorization of the email message includes the extraction of the unique Identifier generated for the sender from the received mail server and querying a domain name server based upon this unique hostname; and transmitting a verification result to the recipient mail server.

According to one embodiment of the present invention, a system for delivering electronic messages from a sender to a recipient over a communications network is disclosed. The system includes one or more processors; one or more memories coupled to the one or more processors; and program instructions stored in the one or more memories, the one or more processors being operable to execute the program instructions, the program instructions including: receiving a delivery request from a sender mail server, the delivery request including a recipient email address and a sender identification; generating a unique identifier for the message from the sender to the recipient; storing a hostname on a domain name server based upon the unique identifier for email transmission authorization; receiving an email message verification request from a recipient mail server; verifying authorization of an email message, wherein verifying authorization of the email message includes the extraction of the unique identifier generated for the sender from the received mail server and querying a domain name server based upon this unique hostname; and transmitting a verification result to the recipient mail server.

In one embodiment of the Invention, verifying authorization of the email message includes retrieving the hostname from the domain name server. Successful retrieval of the hostname from the domain name server may be an Indication that the email has been authorized for delivery. According to another embodiment, the verification result allows transmission of the email where first and second component values of the resolved hostname match with encoded values of the sender and recipient addresses respectively. According to another embodiment, the verification result allows transmission of the email where the value of only the first component of the resolved hostname matches with the encoded value of the sender address. According to another embodiment, the verification result disallows transmission of the email where the hostname is not found in the domain name server, where either the first or second components of the resolved hostname do not match the encoded values of the sender or recipient addresses respectively, or where the first component value of the resolved hostname does not match the encoded value of the sender address.

### BRIEF DESCRIPTION OF THE DRAWINGS

These and other features, aspects, and advantages of the present invention will become better understood with regard to the following description and accompanying drawings where:

FIG. 1 is a block diagram of a communications network in accordance with an embodiment of the present Invention.

FIG. 2 is a flowchart diagram of a vender delivery request in accordance with an embodiment of the present invention.

FIG. 3 is a flowchart diagram of an email delivery in accordance with an embodiment of the present invention.

FIG. 4 is a block diagram of a communications network in accordance with an embodiment of the present invention.

### DETAILED DESCRIPTION

The detailed description set forth below In connection with the appended drawings is intended as a description of example embodiments of the present invention and is not intended to represent the only embodiments in which the present invention can be practiced. The embodiments described throughout this description are Intended to serve as an example or illustration of the present Invention and should not necessarily be construed as preferred or advantageous over other embodiments. Any number of the described embodiments may be Incorporated in any desired combination. The detailed description Includes specific details for the purpose of providing a thorough understanding of the present invention. However, it will be apparent to those skilled In the art that the present invention may be practiced without these specific details.

In the following description, reference Is made to the accompanying drawings, which form a part hereof, and through which is shown by way of illustration specific embodiments In which the invention may be practiced. It Is to be understood that other embodiments may be used as structural and other changes may be made without departing from the scope of the present invention.

The present invention provides an electronic message delivery system for senders of email to deliver their email and electronic messages without the risk of being blocked by an email filtering system. The delivery system may be used to minimize, reduce, or eliminate the blocking or deletion of legitimate emails by spam filter application. The delivery system includes verification technology to provide a management tool between the sender and the recipient of email messages, and other electronic messages, and also provides a reliable way for recipients to opt out of receiving emails from a particular sender. The delivery system may also be used with email filtering and challenge response systems.

The rise of spam or unsolicited email has resulted In the development of many anti-spam, spam filtering, and spam management systems that block supposedly unwanted email from reaching the intended recipient However, the widespread use of spam management systems has resulted in other problems whereby legitimate email is falsely identified as spam and deleted without any accountability to the sender or the intended recipient Many vendors and businesses are conducting transactions using the Internet and have legitimate reasons to send emails and electronic messages to customers using the Internet. Legitimate senders of email have no way of knowing if their email has been delivered or if it has been blocked or deleted.

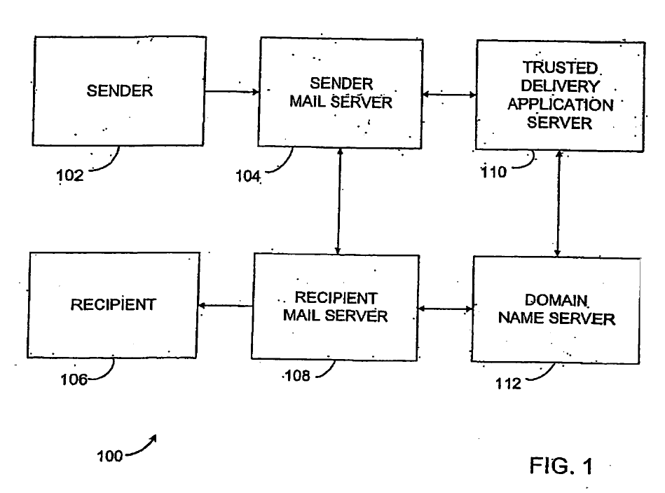

Referring now to FIG. 1, a block diagram of a communications network, in accordance with an embodiment of the present invention, is shown. The network 100 includes a sender 102 of an email operably coupled to a sender mall server 104, and a recipient 106 of the email operably coupled to a recipient mail server 108. The sender mall server 104 is operably coupled to a trusted delivery application server 110 and the recipient mail server 108. The trusted delivery application server 110 and the recipient mail server 108 are each operably coupled to a domain name server 112. The illustrated communications network 100 is only one simplified example of a network used for electronic and Internet communications. Any suitable network configuration may be used. For example, the network may be a short message service (SMS) network or a mobile telephone network used for the transmission of SMS messages or emails.

The sender 102, recipient 104, and the various servers on the network 100 are operably coupled using any suitable communications lines and communications protocols. For example, the sender 102 and the recipient 106 may be coupled to their respective servers using, for example, PSTN lines, DSL lines, a local area network (LAN), a wide area network (WAN), wireless transmissions, or any other suitable communications medium. Communications may be made between parties and devices on the communications network 100 using any suitable communications protocol such as, for example, TCP/IP.

In cooperation with anti-spam or spam filtering technologies, a valid or positive result from the delivery system indicates to the spam filtering system being used that the email message has been authorized and transmission to the recipient is to be allowed. Accordingly, email messages that would have otherwise been blocked or deleted by the spam filtering system will reach the Intended recipient The representation of a valid return may vary as required by the particular spam filtering system being used. In one embodiment, the representation is made by the temporary addition of the sender email address to an “allowed senders” list. In another embodiment, the sender is given a rating that will allow delivery of the email message through the spam filtering system being used.

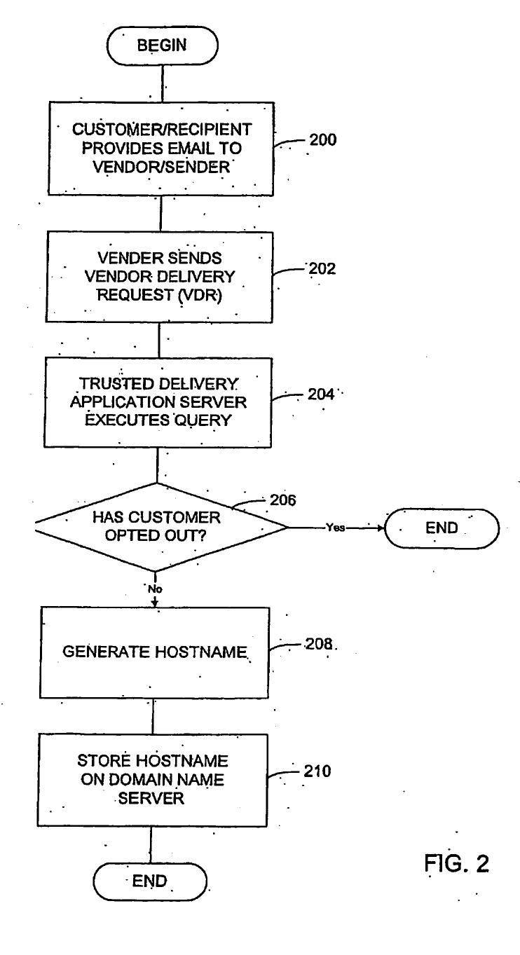

FIG. 2 is a flowchart diagram of a vender delivery request in accordance with an embodiment of the present invention. The illustrated vender delivery request is an example process that the vendor, or the sender of an email, would initiate to send an email to a customer, or the recipient, using the delivery system. A vendor delivery request may be made for a single recipient or a plurality of recipients in a single request.

In step 200, a customer makes an order or purchase from a vendor, also referred to as the sender, and provides the vendor with an email address. Upon processing the order, the vendor communicates with the trusted delivery application server by making a sender delivery request (SDR) to the trusted delivery application server, step 202. The SDR may be made using a platform non-specific transport method such as Simple Object Access Protocol (SOAP) or Representational State Transfer (REST). The SDR may include the recipient email address, the sender email address, or the email address that will be employed for the transmission of email, and details of the business transaction, such as a transaction or purchase number. Any other desired information may be incorporated into the SDR such as, for example, security information, vendor identification, vendor authentication information, a customer status indication, sales receipt, correspondence, a newsletter, promotional material, a service announcement, an invoice, a statement, a survey or questionnaire, reminders, auction notice, security information, vendor authentication information, IP addresses of both the sender and recipient email servers, and any other desired information. The vender may generate the SDR using a SDR script to perform the appropriate actions. The SDR script may be available from the delivery system by downloading from the Internet or using any other suitable delivery method.

In step 204, the trusted delivery application server receives the SDR and performs a query, such as a server or database query, to determine whether the intended recipient has opted=out of receiving correspondence from the sender 102. In step 206, if the customer has opted out of receiving email messages, the process ends and no further action needs to be taken by the trusted delivery application server 110. Additionally, a communication may be made from the trusted delivery application server to the vendor information the vendor that the SDR was refused and the customer at issue has opted out of email receipt. In step 208, if the customer has not opted out, the trusted delivery application server 110 generates a unique identifier that is returned to the sender for incorporation into the mail message. In step 210, the unique identifier is used as the basis for a unique hostname that is stored on the domain name server 112 for subsequent look-up by the recipient mail server 108. Where the recipient mail server using the unique identifier from the mail message performs a look-up, information about the mail message is returned for the purpose of verifying the mail message. This information may be encoded using a one-qay message digest based upon information contained in the email and previously specified in the SDR, such as, for example, the sender and recipient email addresses, information in the message header, or any other type of sender and recipient identifications, using a suitable algorithm that is guaranteed to produce a single unique, repeatable message digest for a given input. Example message digest algorithms include, but are not limited to the RSA Data Security, Inc. MD5 message digest algorithm and the NIST SHA-1 message digest algorithm.

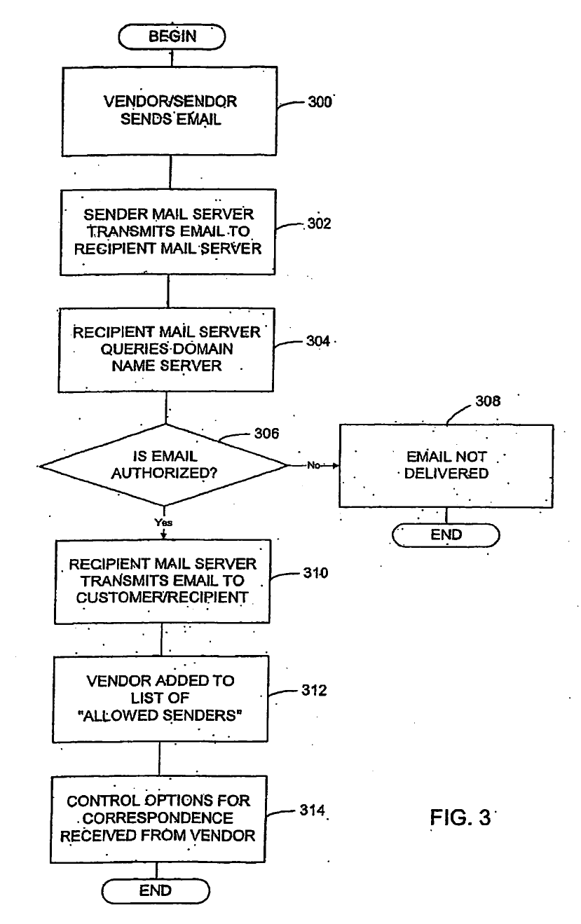

FIG. 3 is a flowchart diagram of an email delivery in accordance with an embodiment of the present invention. In step 300, the vendor dispatches an email to the customer. As part of the dispatch process, the sender mail server receives the email message and transmits it to the recipient mail server, step 302. In step 304, the recipient mail server determines whether the sender and the email message have been authorized. To verify authorization of the sender and email message, the recipient mail server 108, extracts the unique identifier from the received mail message and uses this to generate a hostname for domain name resolution. In step 206, the recipient mail server 108 then looks up this generated hostname in the domain name server 112. The encoded return value from this look-up can be used in conjunction with the one-way message digest employed by the trusted delivery application server to verify details of the mail message. In one embodiment, the return value of the domain name look-up can be separated into two component portions which encoded the sender and recipient email addresses respectively which may be used as the basis for determination of the “validity” of the mail message by the recipient mail server.

If the email Is not authorized, then the email Is not delivered, step 308. A delivery failure notification may be sent to the vendor. In step 310, if the email is authorized, the recipient mail server may forward the email message to the Intended recipient. In step 312, the vendor may be added to an “allowed senders” list such that future emails will be delivered and not blocked by any spam filtering system being used. Depending on the spam filtering system being used, the vendor may be given a particular level of rating such that the filtering system will not block future emails from the vendor. In step 314, the customer may have options included in the email providing the ability to control or opt-out of future correspondence from the vendor. Also, the email may include delivery information explaining how and why the email was delivered to them including, for example, date, email category and status, the sender clearly identified, a unique trusted delivery number, and opt-out functionality.

If the customer chooses to opt-out, the vendor is Informed using an opt out notification email sent to a predetermined address. Customers may also opt out of using the trusted delivery system. The customer may also nominate other vendors that they would like to see using the trusted delivery system.

In one embodiment, the vendor delivery request and the email message sent to the intended recipient are sent simultaneously. In another embodiment, the vendor delivery request and the email message sent to the intended recipient are sent in a single transmission, with the vendor delivery request being incorporated into the dispatch of the email. In another embodiment, the vendor delivery request is sent prior to transmission of the email message.

One implementation of the email delivery system may require the vendors or senders of the email to pay a fee for using the delivery system. For example, the sender may be charged 5 cents for each email sent In another Implementation, the sender may pay an annual registration fee that depends on the volume of email sent by the sender. Also, fees may be charged based on the number of CPUs or IP addresses being used by the sender. Fees may be charged on two or more tiers. For example, one fee scale is used for small to medium businesses and a different fee scale Is used for enterprise or service providers. According to another implementation, the fees received may be divided between the email delivery system and the email/Internet service provider.

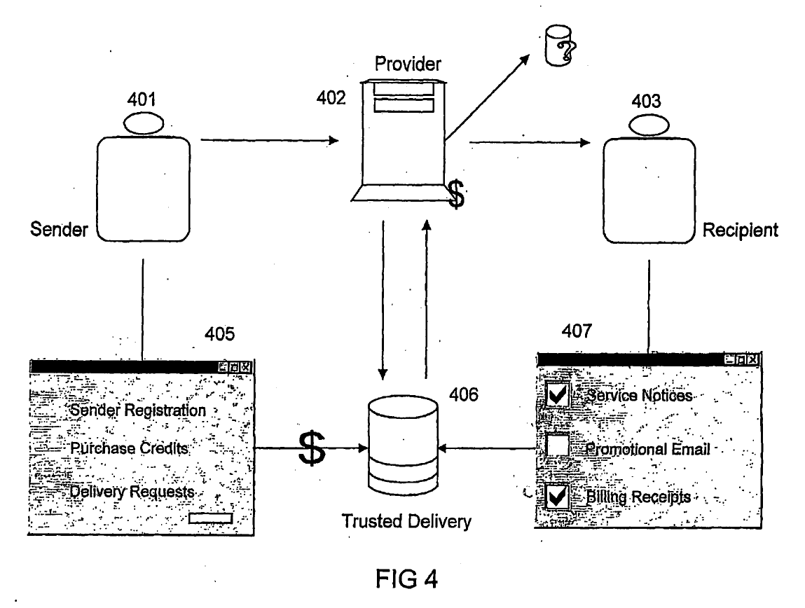

FIG. 4 illustrates another embodiment of the invention. In the system illustrated, Senders 401 registers 505 with the “Trusted Delivery” system 506 and pays a small fee to provide delivery permissions to email Providers 402. Senders incorporate a Trusted Delivery mechanism into their email delivery cycles.

Providers 402 query Trusted Delivery 406 using a simple lookup procedure. Approval or rejection for delivery is based upon Recipient permissions. If an email is not trusted, Providers 402 can subject it to filtering or issue a challenge 404. If an email is trusted, it is delivered to the Recipient 403. The Trusted Delivery system shares revenue with email Providers for each successful delivery.

Recipients 403 can opt out of receiving further emails from Senders 401 by simply clicking on a link contained within the email or by accessing their permissions 407 via a web-based administration tool.

Those skilled in the art will appreciate that the above described system may be implemented in a variety of configurations. For example, specific communication protocols have been Identified with reference to the illustrated mobile network Other suitable communications lines and communication protocols may be used.

The previous description of the example embodiments is provided to enable any person skilled in the art to make or use the present invention. While the invention has been described with respect to particular illustrated embodiments, various modifications to these embodiments will readily be apparent to those skilled In the art, and the generic principles defined herein may be applied to other embodiments without departing from the spirit or scope of the invention. It is therefore desired that the present embodiments be considered in all respects as illustrative and not restrictive. Accordingly, the present invention is not Intended to be limited to the embodiments described above but is to be accorded the widest scope consistent with the principles and novel features disclosed herein.

1. A method for delivering electronic messages from a sender to a recipient over a communications network, the method including:
receiving an email message verification request from a recipient mail server; verifying authorization of an email message, wherein verifying authorization of the email message includes generating a hostname using information in the email message transmission and querying a domain name server using the generated hostname; and
transmitting a verification result to the recipient mail server, wherein the verification result is valid when the generated hostname is successfully retrieved from the domain name server.

2. A method according to claim 1, further including:
receiving a delivery request from a sender mail server, the delivery request including a recipient email address and a sender identification;
generating a unique identifier for the message from the sender to the recipient; and
storing a hostname on a domain name server based upon this unique identifier for email transmission authorization.

3. A method for delivering electronic messages from a sender to a recipient over a communications network, the method including:
receiving a delivery request from a sender mail server, the delivery request including a recipient email address and a sender identification;
generating a unique identifier for the message from the sender to the recipient;
storing a hostname on a domain name server based upon this unique identifier for email transmission authorization;
receiving an email message verification request from a recipient mail server;
verifying authorization of an email message, wherein verifying authorization of the email message includes the extraction of the unique identifier generated for the sender from the received mail server and querying a domain name server based upon this unique hostname; and
transmitting a verification result to the recipient mail server.

4. A method according to claim 3, wherein verifying authorization of the email message includes retrieving the hostname from the domain name server.

5. A method according to claim 3, wherein the verification result allows transmission of the email where first and second component values of the resolved hostname match with encoded values of the sender and recipient addresses respectively.

6. A method according to claim 3, wherein the verification result allows transmission of the email where the value of only a first component of the resolved hostname matches an encoded value of the sender address.

7. A method according to claim 3, wherein the verification result disallows transmission of the email where the hostname is not found in the domain name server, where first or second components of the resolved hostname do not match encoded values of the sender or recipient addresses respectively, or where the first component value of the resolved hostname does not match the encoded value of the sender address.

8. A method according to claim 3, further including adding the sender to a list of allowed senders.

9. A method according to claim 3, further including providing the recipient control options for future correspondence received from the vendor.

10. A method according to claim 3, further including generating a database query to determine whether the recipient has opted out of receiving communications from the sender.

11. A method according to claim 3, wherein the delivery request includes an identification of a sender email address and a recipient email address.

12. A system for delivering electronic messages from a sender to a recipient over a communications network, the system including:
one or more processors;
one or more memories coupled to the one or more processors; and
program instructions stored in the one or more memories, the one or more processors being operable to execute the program instructions, the program instructions including:
receiving a delivery request from a sender mail server, the delivery request including a recipient email address and a sender identification;
generating a unique identifier for the message from the send to the recipient;
storing a hostname on a domain name server based upon this unique identifier for email transmission authorization;
receiving an email message verification request from a recipient mail server;
verifying authorization of an email message, wherein verifying authorization of the email message includes extraction of the unique identifier generated for the sender from the received mail server and querying a domain name server based upon this unique hostname; and
transmitting a verification result to the recipient mail server.

13. A system according to claim 12, wherein verifying authorization of the email message includes retrieving the hostname from the domain name server.

14. A system according to claim 12, wherein the verification result allows transmission of the email where first and second component values of the resolved hostname match with encoded values of the sender and recipient addresses respectively.

15. A system according to claim 12, wherein the verification result allows transmission of the email where the value of only a first component of the resolved hostname matches an encoded value of the sender address.

16. A system according to claim 12, wherein the verification result disallows transmission of the email where the hostname is not found in the domain name server, where first or second components of the resolved hostname do not match encoded values of the sender or recipient addresses respectively, or where the first component value of the resolved hostname does not match the encoded value of the sender address.

17. A system according to claim 12, the program instructions further including adding the sender to a list of allowed senders.

18. A system according to claim 12, the program instructions further including providing the recipient control options for future correspondence received from the vendor.

19. A system according to claim 12, the program instructions further including generating a database query to determine whether the recipient has opted out of receiving communications from the sender.

20. A system according to claim 12, wherein the delivery request includes an identification of a sender email address and a recipient email address.

21. (canceled)

22. (canceled)
